(19) United States
(12) Patent Application Publication
(10) Pub. No.: US 2019/0001235 A1
(43) Pub. Date: Jan. 3, 2019

(54) POOL NOODLE CONNECTOR

(71) Applicant: Bruce Eric KREMMER, Menai (AU)

(72) Inventor: Bruce Eric KREMMER, Menai (AU)

(21) Appl. No.: 15/951,047

(22) Filed: Apr. 11, 2018

(30) Foreign Application Priority Data
Jun. 28, 2017 (AU) 2017204420

(51) Int. Cl. A63H 33/10; A63B 31/00

(52) U.S. Cl. CPC A63H 33/10; B25B 13/08; A63B 31/00

(57) ABSTRACT

An assembly includes at least one barb mount mounted to a pool noodle, and at least one connector module to which the barb mount is inserted and locked onto. The connector module allows other pool noodle ends having a similar barb mount mounted thereto to be attached to the connector module. The barb mount includes a hollow body having an engagement section and a locking section which are separated by a stop flange. The engagement section is adapted for insertion into the central cavity of a pool noodle, at one end of the pool noodle. The locking section is shaped for locking onto a connector module or an accessory module. The locking section includes locking tabs. Each connector module includes a hollow body with open end connection portions. Each connection portion includes at least two lock apertures shaped to receive opposing locking tabs of the barb mount.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to connectors for foam tubes, but is not limited to this application. The invention can for example be used for connecting tubes together.

### 2. Description of Related Art Including Information Disclosed Under 37 CFR 1.97 and 37 CFR 1.98

A foam tube (also called pool noodle or woggle) is a hollow cylindrical piece of polyethylene foam. Foam tubes are used by people for swimming, water play, and for aquatic exercise. They are typically about 160 centimetres in length and 70 to 80 mm in diameter, and having a central cavity extending between ends of the foam tube. The central cavity s typically 20 to 30 mm in diameter. It is desirable to provide a connector for foam tubes to provide new ways for their use.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a connector for hollow foam tubes, the foam tube comprising an elongate body having end faces and a central cavity extending between the end faces, the connector comprising:
at least two mount sections, each mount section adapted for insertion into the central cavity at one end portion of a foam tube to engage an internal surface of the central cavity at the end portion and retain the foam tube to the connector.

In one embodiment, each mount section comprises a stop flange which engages the end face of the foam tube in use.

In another embodiment, each mount section comprises a body having engagement means formed thereon for engaging the internal surface of the central cavity and resist removal of the foam tube end from the connector

In another embodiment, the engagement means comprises circular barbs, triangular barbs, protrusions, ridges, corrugations or a rough surface

In another embodiment, the mount section comprises a tubular body.

In another embodiment, adjacent mount section shares a stop flange therebetween.

In another embodiment, each mount section is dimensioned to be slightly smaller in diameter than the foam tube cavity, with the engagement means being slightly larger in diameter than the foam tube cavity.

In another embodiment, the mount section is dimensioned to provide an interference fit with the foam tube cavity.

In another embodiment, the mount section is dimensioned to have a diameter slightly larger than the foam tube cavity.

In another embodiment, the connector is hollow such that cavities of connected foam tubes are joined in use.

In another embodiment, the mount sections are inline and directed opposite each other.

In another embodiment, the mount sections are parallel to each other.

In another embodiment, the mount sections are joined by a bridging portion.

In another embodiment, adjacent mount sections are oriented at 90° to each other.

In another embodiment, the connector comprises two mount sections being inline with each other and a third mount section being between and at right angles to the two mount sections.

In another embodiment, the connector comprises three mount sections being at right angles to each other.

In another embodiment, the connector comprises two mount sections being inline and two mount sections being between and at right angles thereto.

In another embodiment, the connector comprises four mount sections being at right angles to each other in the same plane.

In another embodiment, the connector comprises four mount sections being at right angles to each other in the same plane and a fifth mount section being between and perpendicular thereto.

In another embodiment, the mount sections share a stop flange oriented at 45° to the mount sections

In another embodiment, the bridging portion is flexible and/or elastic.

In another embodiment, the bridging portion provides an adjustable angle mount section.

In another embodiment, the connector is made from buoyant plastics material.

In another embodiment, the connector has a closed internal cavity.

In another aspect, the present invention provides a foam tube structure comprising at least one connector according to any one of the above.

In another aspect, the present invention provides a kit comprising a plurality of connectors according to any one of the above.

In another aspect, the present invention provides a kit comprising at least one connector according to any one of the above, and a garden hose connector attachment which comprises a mount section at one end and a hose connector fitting at the other end thereof.

In another aspect, the present invention provides a connector for hollow articles, the article comprising an elongate body having end faces and a central cavity extending between the end faces, the connector comprising:
at least two mount sections, each mount section adapted for insertion into the central cavity at one end portion of the article to engage an internal surface of the article at the end portion and retain the article to the connector.

In another aspect, the present invention provides a connector for hollow foam tubes, the foam tube comprising an elongate body having end faces and a central cavity extending between the end faces, the connector comprising:
at least one barb mount, each barb mount having an engagement section and a locking section, each engagement section adapted for insertion into the central cavity at one end portion of a foam tube to engage an internal surface of the central cavity at the end portion and retain the barb mount to the foam tube, and
at least one connector module having at least one end connection portion adapted to receive and lock the locking section therein.

In another embodiment, the barb mount comprises a hollow body and the engagement section and the locking section are separated by a stop flange.

In another embodiment, the engagement section forms about 80% of the length of the barb mount.

In another embodiment, an engagement means in the engagement section is a thread to engage the internal surface of the foam tube cavity.

In another embodiment, the engagement means is spaced from the end of the body.

In another embodiment, the locking section locking tabs which are received in lock apertures of the connector module.

In another embodiment, at least one rotation lug is provided to be engaged by a lock spanner.

In another embodiment, the connector module comprises a hollow body with at least two open end connection portions.

In another embodiment, each connection portion comprises at least two lock apertures formed at diametrically opposing portions thereof, which are shaped to receive opposing locking tabs of the barb mount.

In another embodiment, the lock apertures have ramp lead in portions.

In another embodiment, each lock aperture is associated with a removal recess at an external surface of the connector module.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a perspective view of a foam tube connector in accordance with a first preferred embodiment of the present invention, being an inline two-way connector.

FIG. 2 is a perspective view of a foam tube connector in accordance with a second preferred embodiment of the present invention, being a right angle two-way connector.

FIG. 3 is a perspective view of a foam tube connector in accordance with a third preferred embodiment of the present invention, being an inline three-way connector, two mount sections being inline and the third mount section being at right angle thereto.

FIG. 4 is a perspective view of a foam tube connector in accordance with a fourth preferred embodiment of the present invention, being a corner three-way connector, the mount sections being at right angles to each other.

FIG. 5 is a perspective view of a foam tube connector in accordance with a fifth preferred embodiment of the present invention, being a corner junction four-way connector, two mount sections being inline and two mount sections being at right angles thereto.

FIG. 6 is a perspective view of a foam tube connector in accordance with a sixth preferred embodiment of the present invention, being a cross junction four-way connector, the four mount sections being at right angles to each other in the same plane.

FIG. 7 is a perspective view of a foam tube connector in accordance with a seventh preferred embodiment of the present invention, being a central junction five-way connector, four mount sections being at right angles to each other in the same plane and a fifth mount section being perpendicular thereto.

FIG. 8 shows an example foam tube structure made using the foam tube connectors of the present invention, being a basketball hoop.

FIG. 9 shows another example foam tube structure made using the foam tube connectors of the present invention, being a volleyball net.

FIG. 10 shows other examples of foam tube structures made using the foam tube connectors of the present invention, being a boat and a horse.

FIG. 11 is a perspective view of a modified embodiment of the pool connector of FIG. 2.

FIG. 12 is a perspective view of a modified embodiment of the pool connector of FIG. 3.

FIG. 13 shows a mitre box for cutting ends of foam tubes if needed.

FIG. 14 is a perspective view of a garden hose connector attachment.

FIG. 15A is a side perspective view showing shows a barb mount for a modified embodiment of the foam tube connector.

FIG. 15B is a top perspective view of FIG. 15A.

FIG. 15C is another side perspective view of FIG. 15A.

FIG. 16A is a perspective view of a 4-way connector module for the modified embodiment.

FIG. 16B is a front elevation view of FIG. 16A.

FIG. 17 shows a spanner tool for the barb mount.

FIG. 18 shows an example foam tube structure.

FIG. 19A is a perspective view showing a different function of the spanner tool.

FIG. 19B is a perspective view of another different function of the spanner tool.

FIG. 19C is a perspective view of still another different function of the spanner tool.

FIG. 20A is a perspective view of a connector module, in particular, a joiner.

FIG. 20B is a perspective view of another connector module, in particular, a 90-degree connector module.

FIG. 20C is a perspective view of another connector module, in particular, an extension connector module.

FIG. 20D is a perspective view of another connector module, in particular, a 3-way corner.

FIG. 20E is a perspective view of another connector module, in particular, a 3-way Tee.

FIG. 20F is a perspective view of another connector module, in particular, a 4-way cross.

FIG. 20G is a perspective view of another connector module, in particular, a 6-way connector module.

FIG. 20H is a perspective view of another connector module, in particular, a 135-degree joiner.

FIG. 21A is a perspective view of another accessory module, in particular, a water connector.

FIG. 21B is a perspective view of another accessory module, in particular, a water sprayer.

FIG. 21C is a perspective view of another accessory module, in particular, a sumo sword joiner.

FIG. 21D is a perspective view of another accessory module, in particular, a loop screw.

FIG. 21E is a perspective view of another accessory module, in particular, a hidden joiner for a forming a loop.

FIG. 21F is a perspective view of another accessory module, in particular, another hidden joinder for forming a loop.

FIG. 22 shows a modified embodiment of the barb mount of FIGS. 15A, 15B and 15C.

FIG. 23 shows modified embodiment of the connector module of FIGS. 16A and 16B.

FIG. 24 shows a dual-ended spanner.

FIG. 25 shows a foam tube configured into a ring.

### DETAILED DESCRIPTION OF THE INVENTION

It should be noted in the following description that like or the same reference numerals in different embodiments denote the same or similar features.

FIG. 1 shows a foam tube connector 20a according to a first preferred embodiment of the present invention. The connector 20a comprises two mount sections 22 separated by a stop flange 24.

Each mount section 22 in the connectors will typically have a respective stop flange 24, but some adjacent mount sections 22 can share a stop flange 24 as described below.

Each mount section 22 is adapted for insertion into the central cavity of a foam tube, at one end of the foam tube. The mount section 22 is fully inserted into the cavity until the stop flange 24 engages the end face of the foam tube. Each mount section 22 comprises a tubular body 25 with spaced engagement means 26 formed thereon. The engagement means 26 in the embodiment are circular barbs to engage the internal surface of the cavity to resist removal of the foam tube end from the connector 20a.

Each mount section is typically 50 to 100 mm long. The body 25 is dimensioned to be slightly smaller in diameter compared to the diameter of the foam tube cavity, with the engagement means 26 then being slightly larger in diameter than the foam tube cavity. This will allow fit insertion of the mount section 22 into the foam tube end, with the engagement means 26 preventing easy removal therefrom.

In other possible modifications, other forms of engagement means 26 can be used, such as triangular barbs, protrusions, ridges, corrugations or a rough surface. Alternatively, the engagement means 26 can be omitted with the body 25 dimensioned to provide an interference fit with the foam tube cavity. The body 25 for example can be dimensioned to have a diameter slightly larger than the foam tube cavity.

The mount sections 22 in the connector 20a are inline and directed opposite each other, which will allow inline connection to two foam tubes to each other. The connector 20a is hollow which results in the hollow cavities of the connected foam tubes being joined.

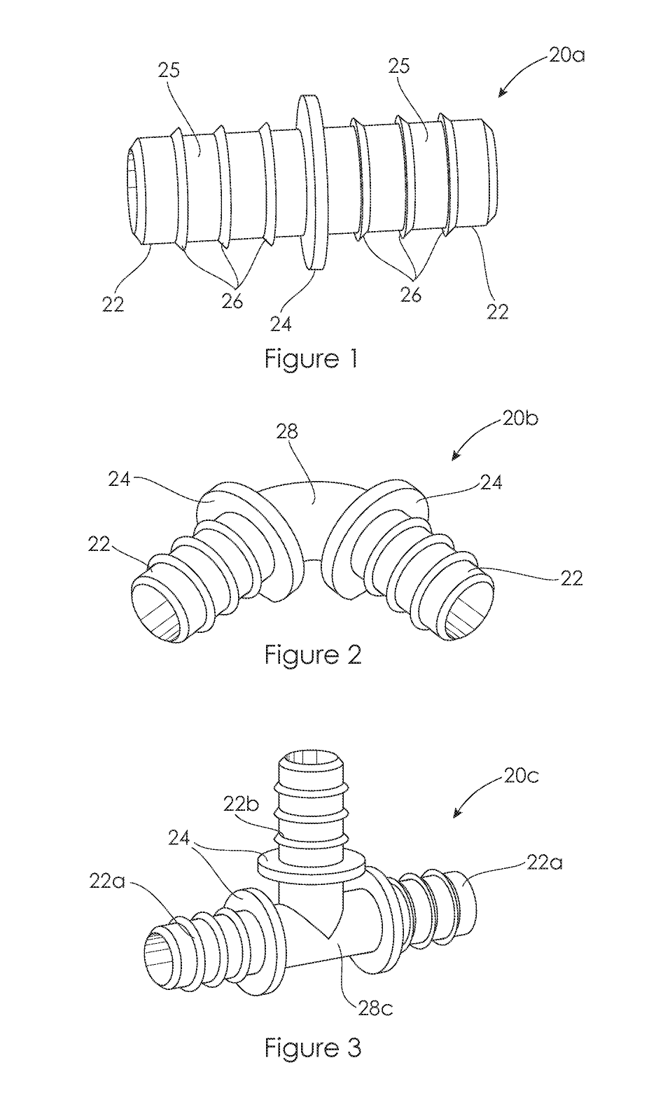

FIG. 2 shows a foam tube connector 20b in accordance with a second preferred embodiment of the present invention, being a right angle two-way connector. The connector 20b similarly comprises two mount sections 22, with each mount section 22 having a respective stop flange 24. The mount sections 22 are oriented at 90° to each other and are joined by a curved tubular bridging portion 28b. The connector 20b is also hollow which results in the hollow cavities of the connected foam tubes being joined.

FIG. 3 shows a foam tube connector 20c in accordance with a third preferred embodiment of the present invention, being an inline three-way connector. The connector 20c has two mount sections 22a being inline with each other and the third mount section 22b being between and at right angles to the mount sections 22a. The mount sections are joined by a generally T-shaped bridging portion 28c. The connector 20c is also hollow which results in the hollow cavities of the connected foam tubes being joined.

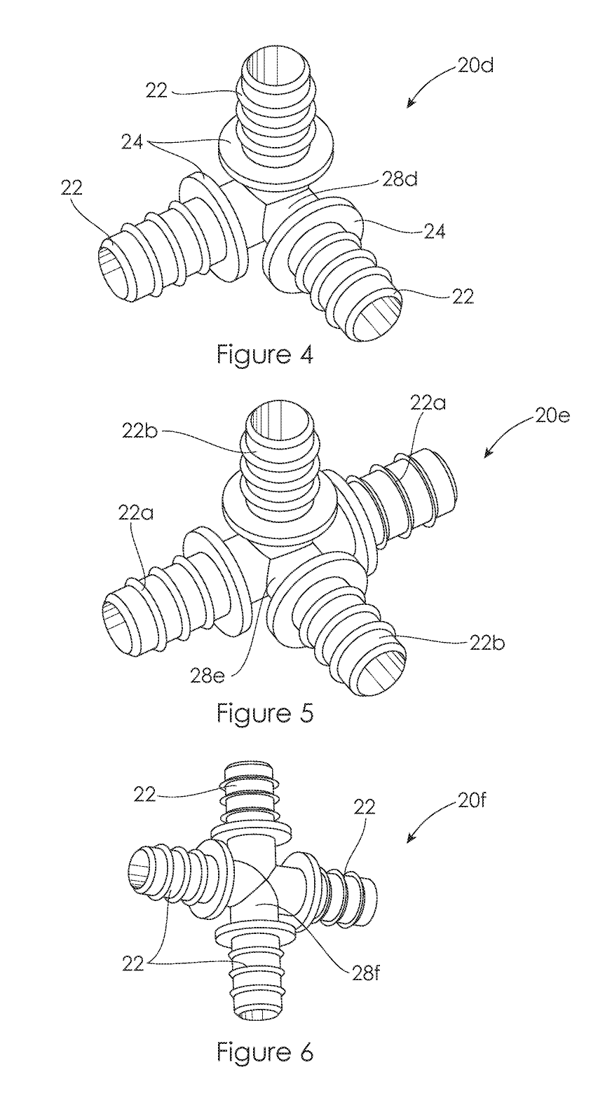

FIG. 4 shows a foam tube connector 20d in accordance with a fourth preferred embodiment of the present invention, being a corner three-way connector. The connector 20d includes three mount sections 22 being at right angles to each other, joined by a correspondingly shaped bridging portion 28d.

FIG. 5 shows a foam tube connector 20e in accordance with a fifth preferred embodiment of the present invention, being a corner junction four-way connector. The connector 20e comprises two mount sections 22a being inline and two mount sections 22b being between and at right angles thereto. The mount sections 22 are joined by a correspondingly shaped bridging portion 28e.

FIG. 6 shows a foam tube connector 20f in accordance with a sixth preferred embodiment of the present invention, being a cross junction four-way connector. The connector 20f has four mount sections 22 being at right angles to each other in the same plane thus forming a cross. The mount sections 22 are joined by a correspondingly cross-shaped bridging portion 28f.

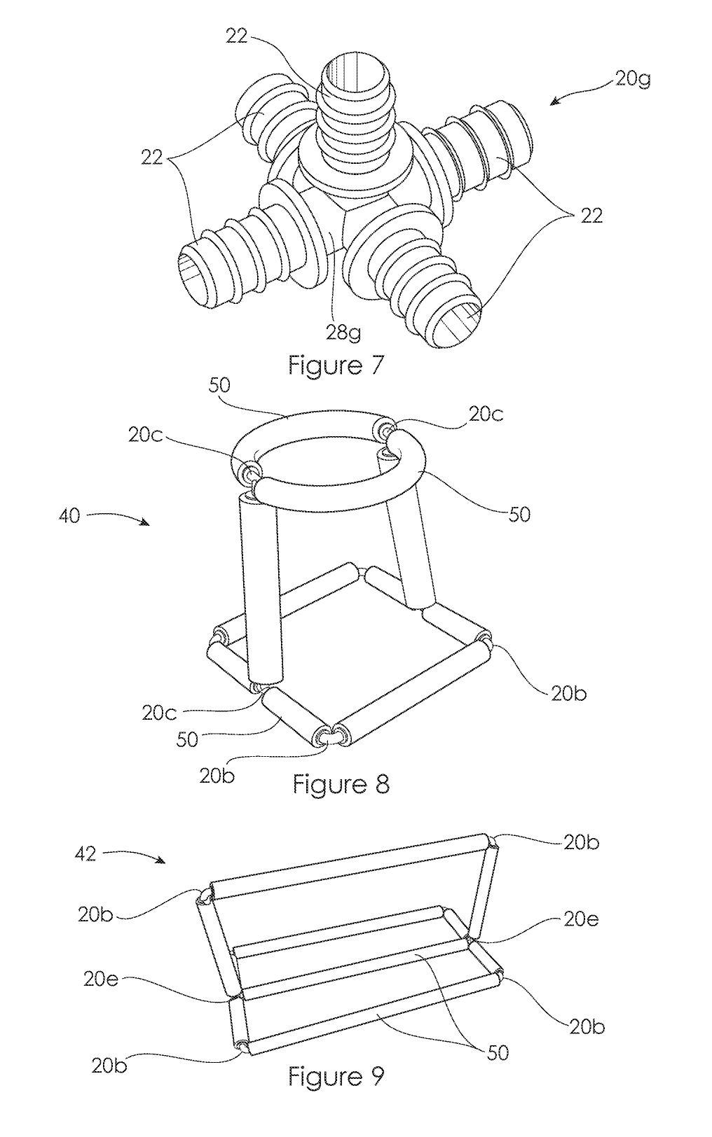

FIG. 7 shows a foam tube connector 20g in accordance with a seventh preferred embodiment of the present invention, being a central junction five-way connector. The connector 20g has four mount sections 22a being at right angles to each other in the same plane and a fifth mount section 22b being between and perpendicular thereto. The mount sections 22 are joined by a correspondingly shaped bridging portion 28g.

FIG. 8 shows an example foam tube structure 40 being a basketball hoop made using foam tubes 50 and the foam tube connectors 20. The foam tubes 50 are cut to length as desired and connected using the foam tube connectors 20. The structure base 42 for example uses the 90° connector 20b and the inline 3-way connector 20c. The hoop 44 uses the inline 3-way connector 20c and curved foam tubes 50.

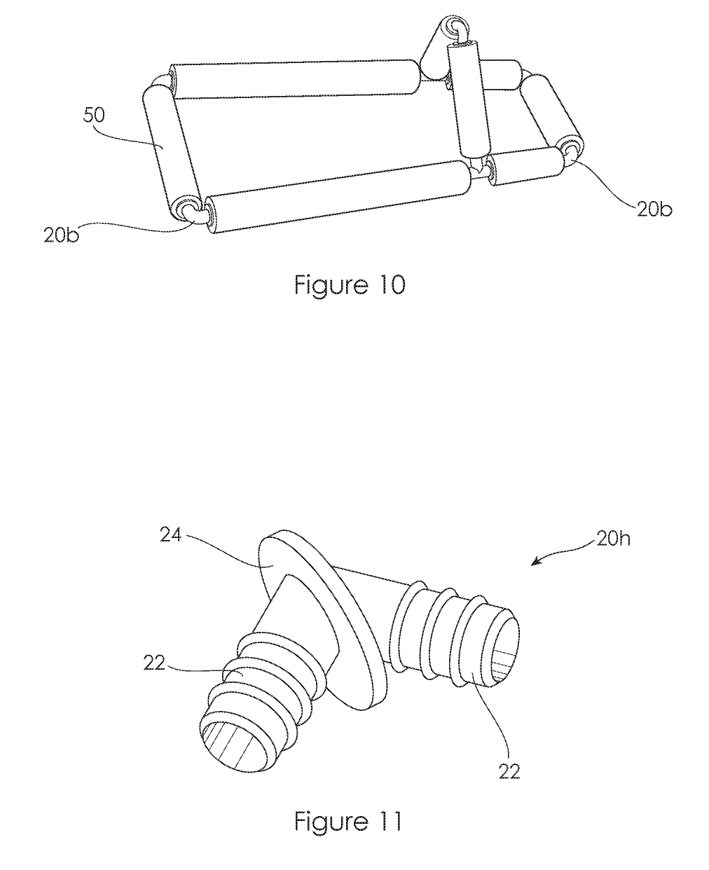

FIG. 9 shows another example foam tube structure 42 being a volleyball net using foam tubes 50 and the connectors 20b and 20e. FIG. 10 shows other examples of foam tube structures using foam tubes 50 and the connectors 20, being a boat and a horse;

FIG. 11 shows a modified embodiment 20h of the pool connector 20b. In this embodiment, the bridging portion 28 is omitted and the mount sections 22 share a stop flange 24 oriented at 45° to the mount sections 22 which are oriented at 90°. The connector 20h requires the end sections of the foam tubes 50 to be mitre cut (45°) to provide a flush engagement with the stop flange 24. FIG. 13 shows a mitre box 60 for cutting ends of the foam tubes 50 as needed. The mitre box 60 will receive the foam tubes and has cut grooves 62 thereon oriented at the required angle as guides for an appropriate saw.

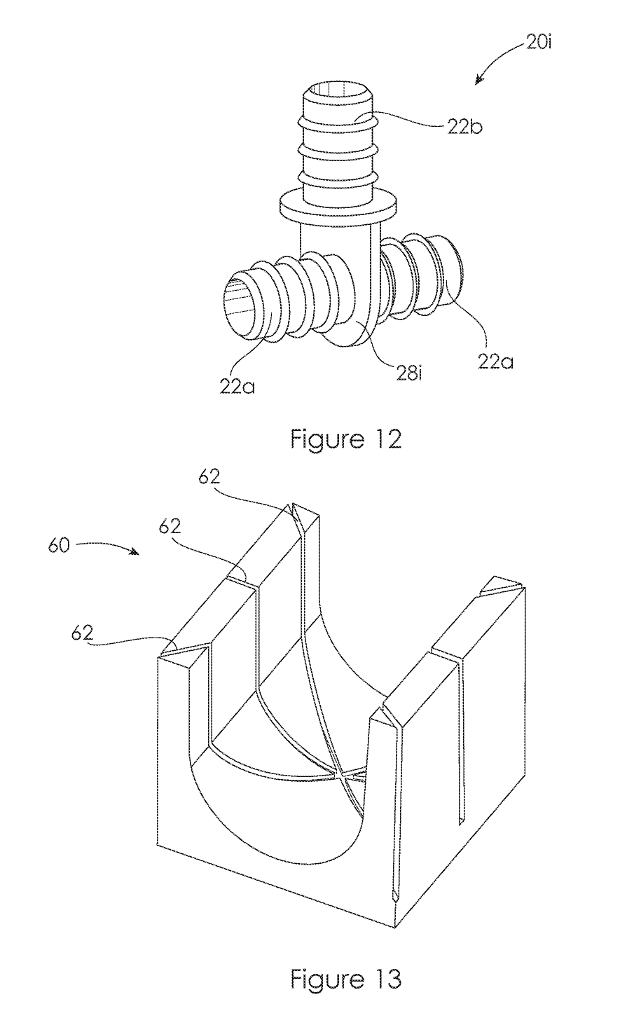

FIG. 12 shows a modified embodiment 20i of the foam tube connector 20c. The bridging portion 28i in this embodiment is an enlarged flange which acts as an end flange for two mount sections 22a and as connector for the third mount section 22b.

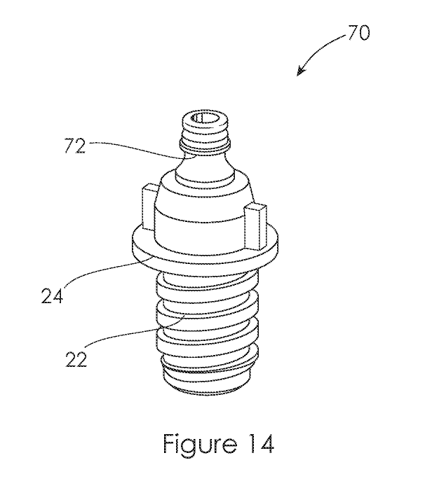

As noted above, the connectors 20 are hollow and will connect the cavities of the attached foam tubes 50. FIG. 14 shows a garden hose connector attachment 70 which comprises a mount section 22 at one end and a hose connector fitting 72 at the other end thereof. The mount section 22 of the garden hose connector attachment 70 can thus be attached to a free end of a foam tube with the hose connector fitting 72 attached to a garden hose to convey water through the foam tubes as desired.

The connectors 20 are preferably made from plastics material, preferably buoyant plastics material. The connectors can be alternatively be or can have a closed internal cavity.

The present invention thus provides connectors using an interference fit to connect foam tubes together to allow the user to create items. The connectors will be available as a kit to make certain items e.g. the hoop and volleyball net, or as individual items.

Whilst preferred embodiments of the present invention have been described, it will be apparent to skilled persons that modifications can be made to the embodiments described. For example, flexible bridging portions 28 can be provided, such as made from flexible plastics, rope or cable. The bridging portions can also be elastic. The bridging portions can alternatively provide an adjustable angle connector, such as by having pivotable mount portions.

The connector can also have two or more mount sections extending in parallel to each other or at an acute angle to each other, joined by a U-shaped or V-shaped bridging portion for example.

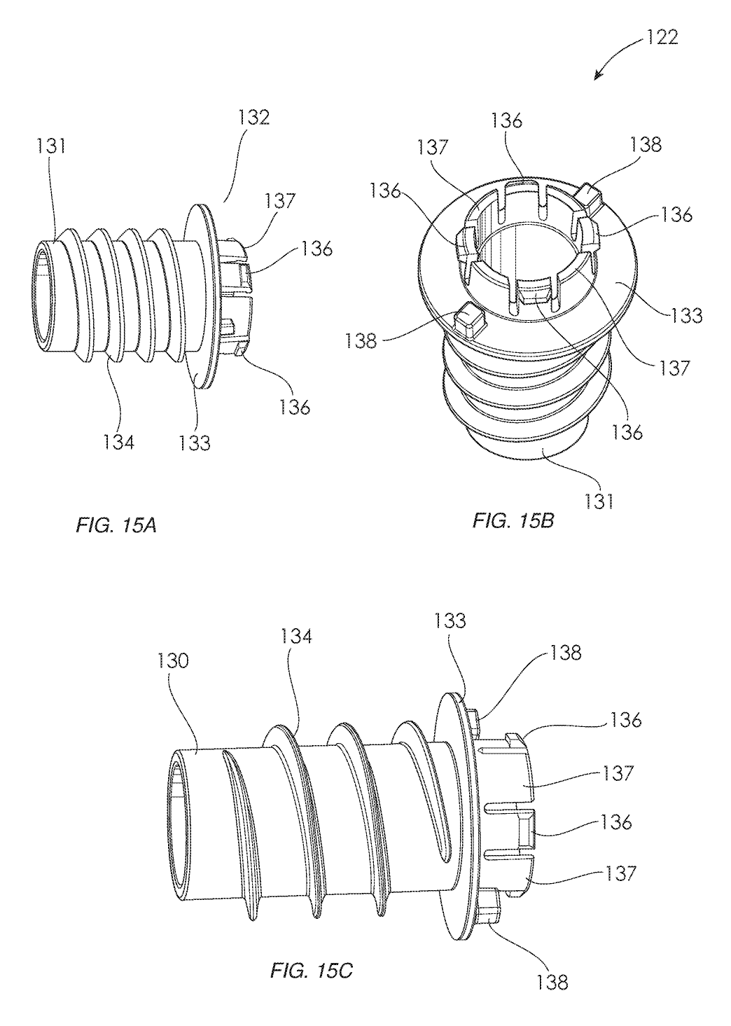

FIGS. 15A to 21F generally relate to an assembly comprising at least one barb mount 122 mounted to a foam tube 50, and at least one connector module 120 to which the barb mount 122 is inserted and locked onto. The connector module 120 then allows other foam tube ends having a similar barb mount 122 mounted thereto to be attached to the connector module 120.

FIGS. 15A, 15B, and 15C show the barb mount 122 which comprises a hollow body 130 having an engagement section 131 and a locking section 132 which are separated by a stop flange 133. The engagement section 131 is adapted for insertion into the central cavity of a foam tube, at one end of the foam tube. The engagement section 131 forms about 80% of the length of the barb mount 122, and is fully inserted into the cavity until the stop flange 133 engages the end face of the foam tube.

The engagement means in the engagement section 131 is a thread 134 to engage the internal surface of the foam tube cavity to lock onto and resist removal from the foam tube end. The engagement means can however be in another form such as spikes, circular barbs or other forms as described above. The outside diameter of the body 130 is designed to provide a secure fit into hollow noodles 50. The thread 134 is spaced from the end of the body 130, and the distance from the end of the body to the first thread is to allow the barb mount 122 to remain in the noodle before the thread engages. This makes screwing in simpler for children. The length of the engagement section is designed to provide a strong connection inside the foam noodle. The thread cross section and pitch design balances the torque required to screw in the barb and the holding power of the barb in the foam noodle. The main outside diameter of the barb body is slightly larger than the inside diameter of the foam tube cavity to give an interference fit.

The locking section 132 is shaped for locking onto a connector module 120 or an accessory module 140. The locking section 132 comprises locking tabs 136 which are spaced in a circular manner at 90° spacing. Between the locking tabs 136 are spacer tabs 137. Two lugs 138 are formed adjacent opposing spacer tabs 137.

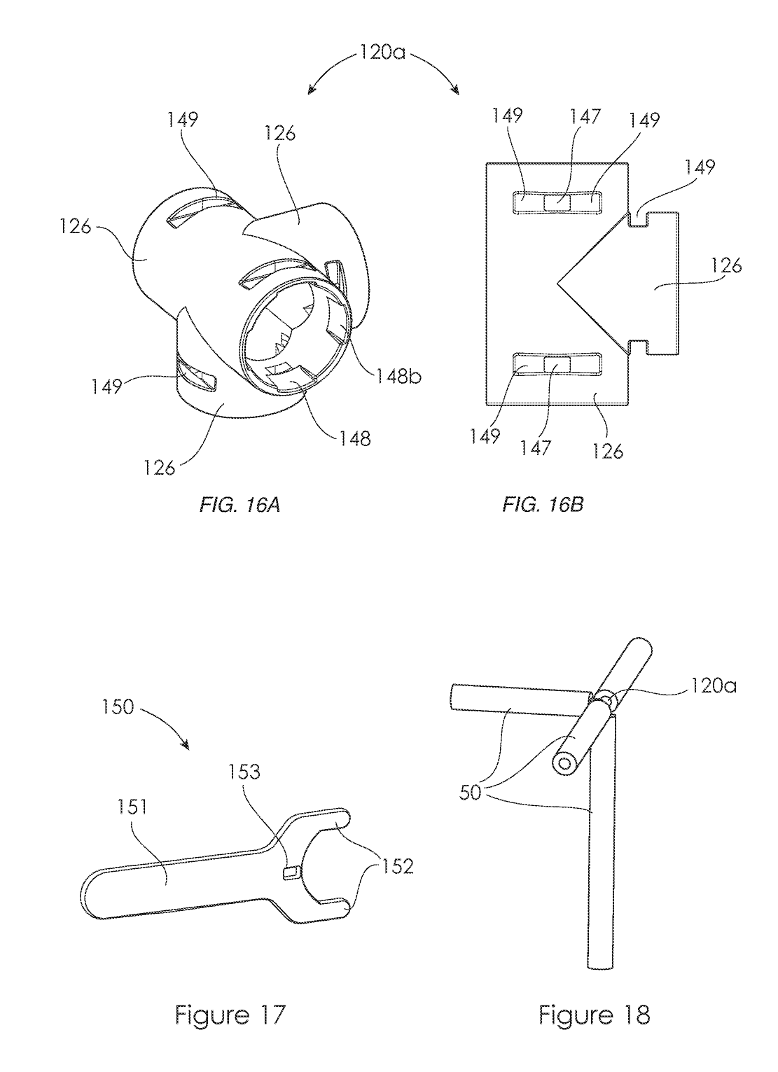

An example connector module 120 is shown in FIGS. 16A and 16B, which is a 4-way connector module 120a. Each connector module 120 comprises a hollow body with open end connection portions 126, the module 120a having four connection portions 126. Each connection portion 126 comprises at least two lock apertures 147 formed at diametrically opposing portions thereof, which are shaped to receive opposing locking tabs 136 of the barb mount 122. The lock aperture cutouts 147 allow the barb locking tabs to fit securely therein and stop rotation. The lock apertures 147 have ramp lead in portions 148 to assist with insertion of the locking tabs 136 therein. The ramps 148 allow the easy connection of the barb and modules. Each lock aperture 147 is associated with a removal recess 149 at an external surface of the connector module 120. The removal recesses 149 in each connection portion 126 are parallel.

The other two locking tabs 136 are not located in any lock apertures 147 in use and can be located in respective ramp lead in portions 148b which are not associated with a lock aperture. There are two sets of locking tabs 136 mate with the single set of lock apertures 147 in the connection modules to make it more likely to mate given the random nature of screwing the barb fittings in either end of the foam noodle. The locking tab width design is to fit into the module to stop rotation.

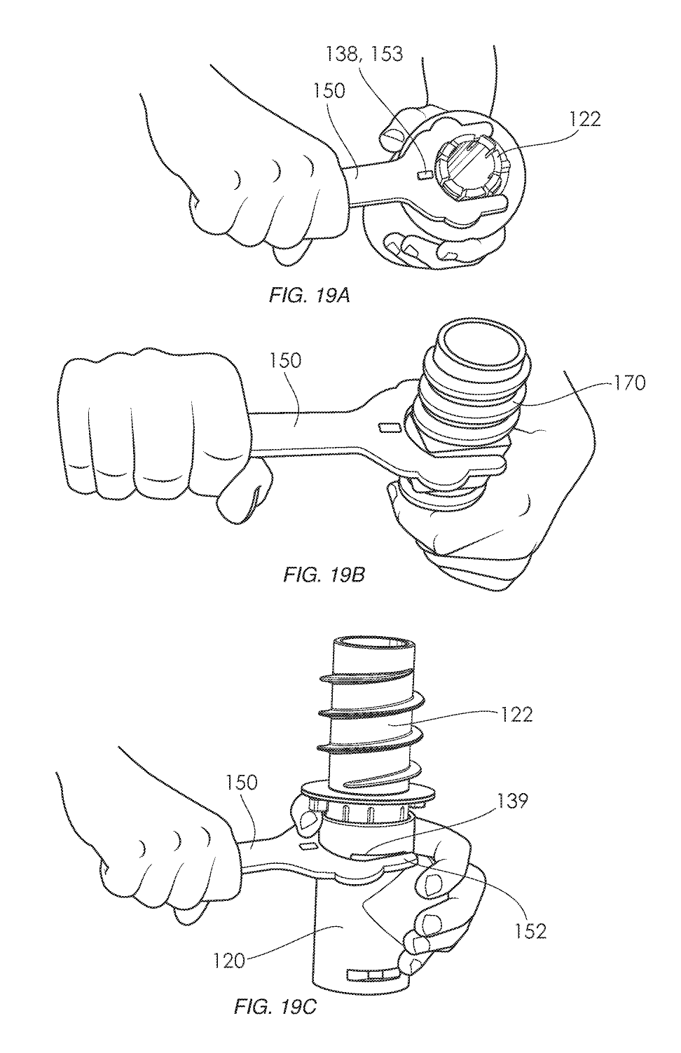

FIG. 17 shows a spanner tool 150 for the barb mount 122. The spanner tool comprises a handle 151, spaced arms 152, and a slot 153 between the arms 152. FIGS. 19A, 19B, and 19C show different functions of the spanner tool, which includes (a) use of the slot 153 to lock a lug 138 therein for rotating a barb mount 122 for locking to or unlocking from a foam tube end, the lugs fit with the spanner to easily screw the barb into the hollow foam noodle (b) using the spaced arms 152 as a spanner, and (c) using the spaced arms 152 to fit into the external removal recesses 139 to push the locking tabs 136 inwardly for removing a barb mount 122 from a connector module 120. The distance and depth of cutouts 139 allows the spanner arms 152 to fit over the module 120 and push the barbs tabs 136 to allow the parts to be disconnected and re-used. FIG. 18 shows an example foam tube structure which is a horse using the connector module 120a, four barb mounts 122 and four foam tubes 50.

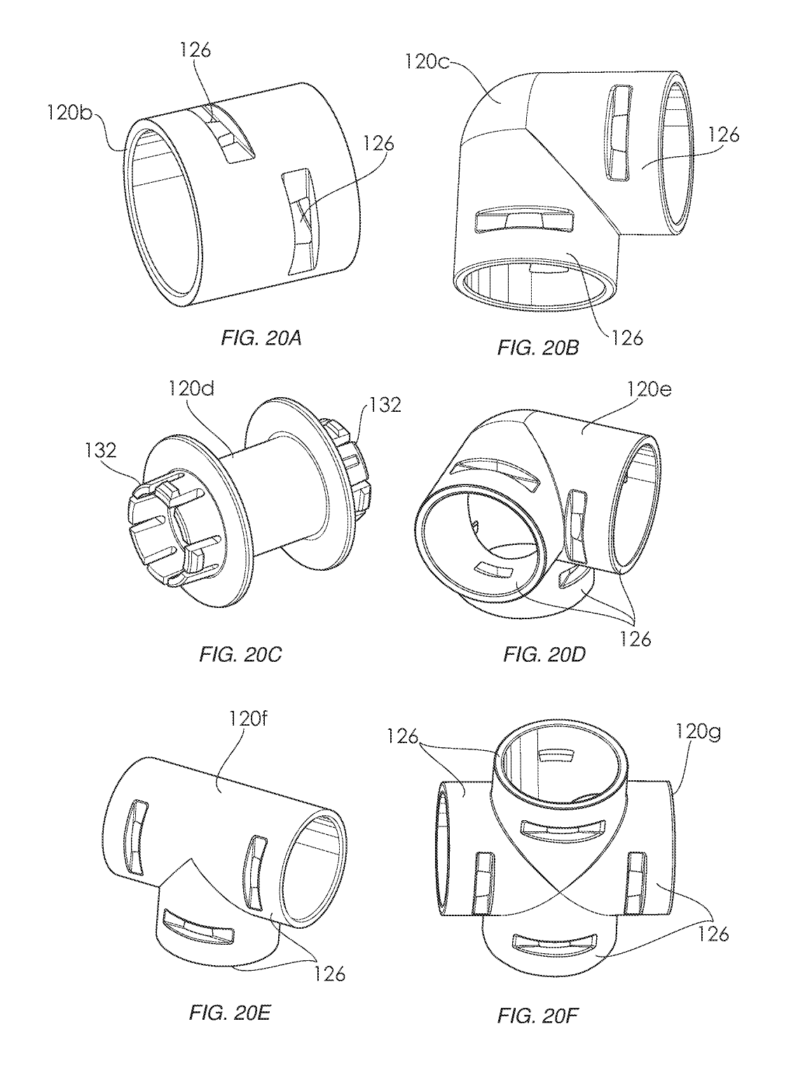

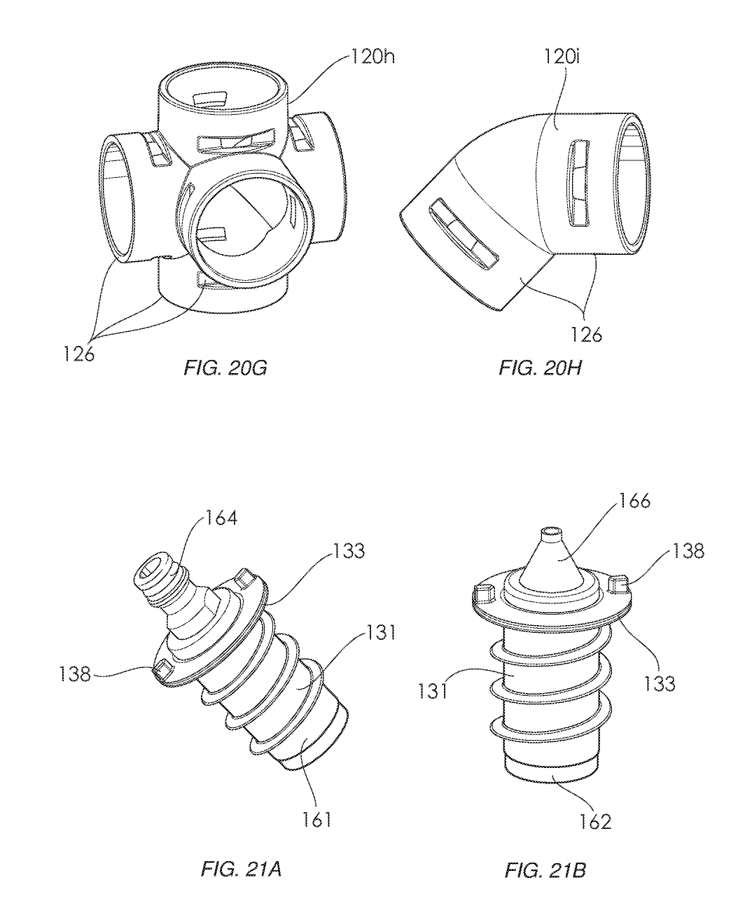

FIGS. 20A, 20B, 20C, 20D, 20E, 20F, 20G, and 20H show different connector modules, being (a) joiner module 120b for connecting foam tubes in line, (b) 90 degree module 120c for connecting foam tubes in a 90° orientation, (c) extension module 120d having two locking sections 132 for connecting two modules 120, (d) 3-way corner module 120e for connecting foam tubes in a corner orientation, (e) 3-way Tee module 120f for connecting foam tubes in a T-shaped orientation, (f) 4-way cross module 120g for connecting foam tubes in a cross orientation, (g) 6-way module 120h for connecting foam tubes in a 6-way orientation, and (h) 135 degree joiner module 120i for connecting foam tubes in a corner orientation 135° join.

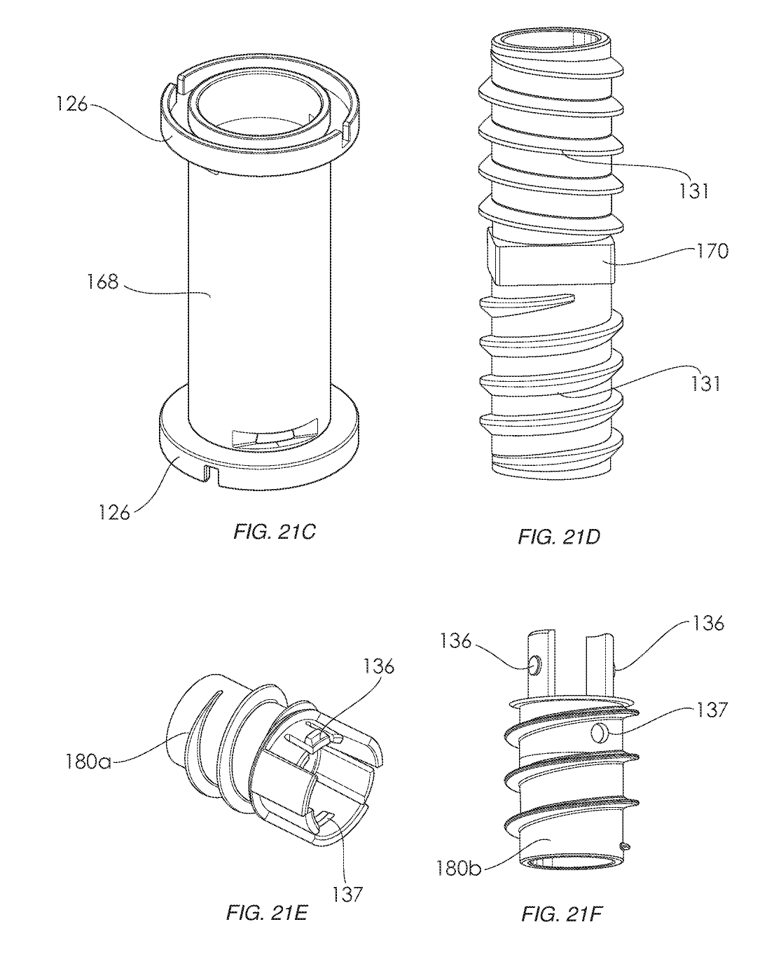

FIGS. 21A, 21B, 21C, 21D, 21E and 21F show different accessory modules being (a) water connector 161 having an engagement section 131 and a hose connector 164 instead of a locking section 132, (b) water sprayer 162 having an engagement section 131 and a spray spout 166 instead of a locking section 132, (c) sumo sword joiner 168 having two opposing connection portions 126, and (d) loop screw 170 having two opposing engagement sections 131.

FIGS. 21E and 21F show loop joiners 180, where two such joiners 180 are mounted to opposite ends of a foam tube 50 and the joiners 180 are joined to each other to form a foam tube loop. FIG. 21E shows hidden joiner 180a having engagement section 131 and a locking section 132 with a locking tab 136 at one side and a locking aperture 137 at the opposite side. FIG. 21F shows another hidden joiner 180b having spaced opposing locking tabs 136, and where the locking apertures are formed in the engagement section 131.

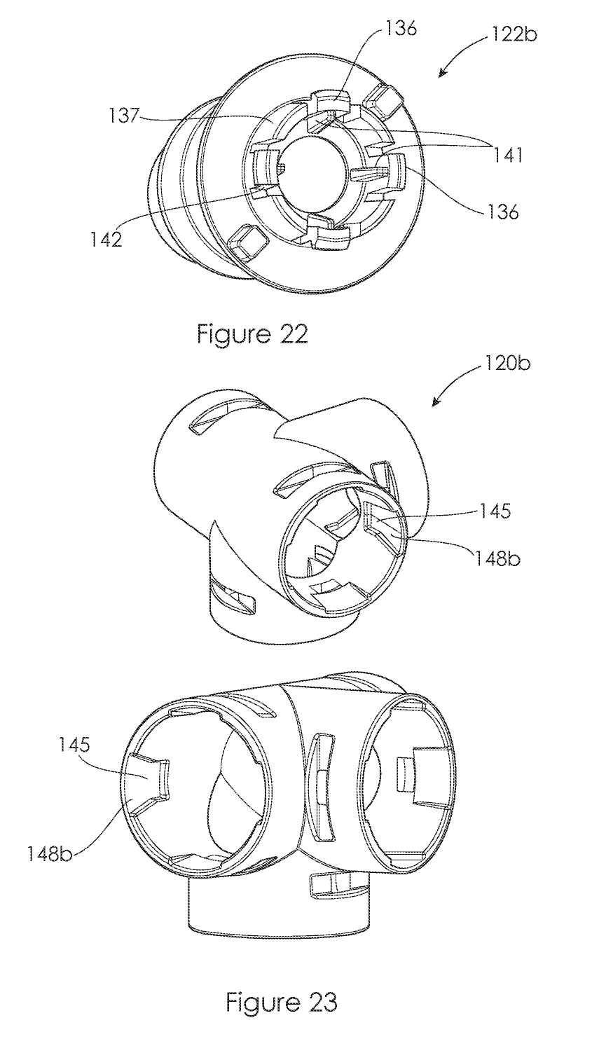

FIG. 22 shows a barb mount 122b similar to the barb mount 122 of FIGS. 15A, 15B, and 15C. In this embodiment, the locking tabs 136 comprise strengthening ribs 141, and the base sections of the locking tabs 136 and the spacer tabs 137 are joined together by a support ring 142 to give the locking tabs greater strength to stop them from being pulled out under high tension.

FIG. 23 shows another example connector module 120b similar to that shown in FIGS. 16A and 16B. In this embodiment, slots 145 are added to the ramp lead in portions 148b so that the second pair of locking tabs 137 not located in the lock apertures 147 are not compressed in when the barb mount 122b and module 120b are locked together. This slot 145 and the locking tab 137 stops any rotation between these parts ensuring they remain firmly locked in place. The ramp lead in portions 148 comprise side sections which are tapered/converge towards the slots 145 to assist location of the locking tabs 137 therein.

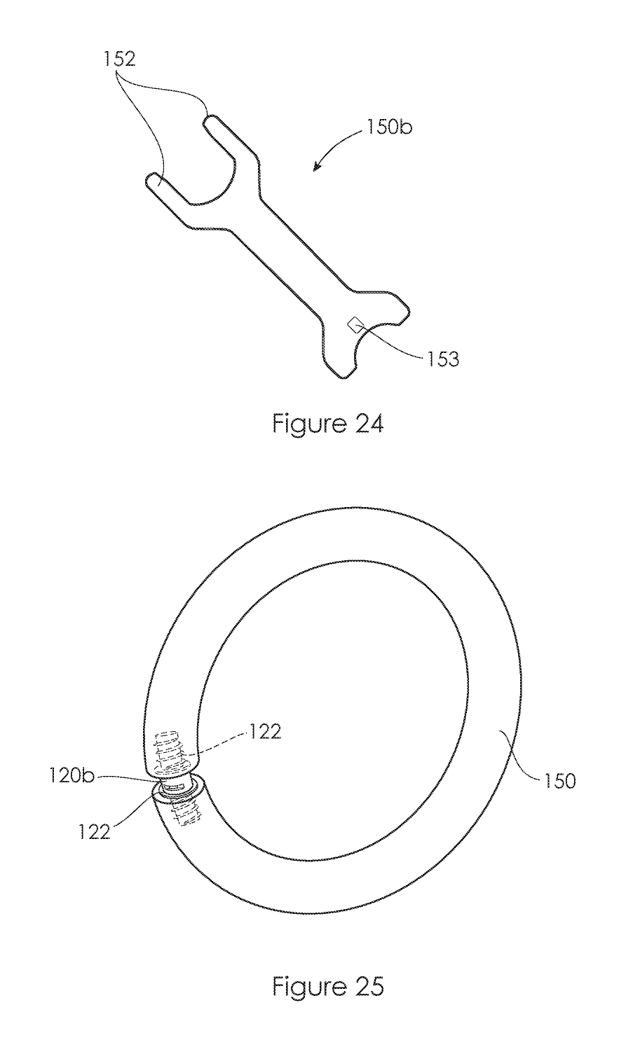

FIG. 24 shows a dual-ended spanner 150b having the slot 153 at one end for rotating and screwing the barb 122b, and spaced arms 152 at the other end which goes in the module removal recess slots 149 to release the barb locking tabs and release the barb.

FIG. 25 shows a foam tube 50 configured into a ring with end connectors 122 at each end, with the connectors 122 connected to a joiner 120b (FIGS. 20A, 20B, 20C, 20D, 20E, 20F, 20G, and 20H).

1. A connector for hollow foam tubes, the each foam tube comprising an elongate body having end portions and a central cavity extending between the end portions, the connector comprising:
a barb mount having an engagement section and a locking section, the engagement section adapted for insertion into the central cavity of one end portion of the foam tube to engage an internal surface of the central cavity at the end portion and retain the barb mount to the foam tube, and
a connector module having at least one end connection portion adapted to receive and lock the locking section of the barb mount therein.

2. The connector of claim 1, wherein the barb mount comprises a hollow body and wherein the engagement section and the locking section are separated by a stop flange.

3. The connector of claim 1 wherein the engagement section comprises a thread to engage the internal surface of the foam tube cavity.

4. The connector of claim 3 wherein the thread is spaced from the end portion of the body.

5. The connector of claim 1 wherein the locking section comprises locking tabs which are received in lock apertures of the connector module.

6. The connector of claim 1 wherein the barb mount comprises at least one rotation lug for engagement by a lock spanner.

7. The connector of claim 1 wherein the connector module comprises a hollow body with at least two open end connection portions.

8. The connector of claim 7, wherein each connection portion comprises at least two lock apertures formed at diametrically opposing portions thereof, each lock aperture being shaped to receive opposing locking tabs of the barb mount.

9. The connector of claim 8 wherein the lock apertures have ramp lead in portions.

10. The connector of claim 8 wherein each lock aperture is associated with a removal recess at an external surface of the connector module.

11. The connector of claim 7 wherein the connector module is flexible and/or elastic.

12. The connector of claim 7 wherein the connector module provides an adjustable angle between the connection portions.

13. The connector of claim 1 wherein the connector is comprised of buoyant plastics material.

14. The connector of claim 1 wherein the barb mount has a closed internal cavity.

15. A kit, comprising: a plurality of connectors, each connector, according to claim 1.
